(19) United States
(12) Patent Application Publication
(10) Pub. No.: US 2004/0249953 A1
(43) Pub. Date: Dec. 9, 2004

(54) Peer-to-peer instant messaging

(75) Inventors: Roland Fernandez, Woodinville, WA (US); Iain Hackett, Port Vila (VU); Wistar D. Rinearson, Redmond, WA (US); Michael Williams, Seattle, WA (US); Susan D. Woolf, Seattle, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/436,977

(22) Filed: May 14, 2003

(51) Int. Cl. G06F 15/16

(52) U.S. Cl. 709/227

(57) ABSTRACT

A peer-to-peer wireless instant messaging system is described. A user may establish a wireless instant messaging communication pathway with other users either using a server or directly. In some aspects of the present invention, a user may use an intermediate user's connection to reach another user, who is out of range of the first user.

### BACKGROUND OF THE INVENTION

1. Field of the Invention

Aspects of the present invention relate to communication techniques. More specifically, aspects of the present invention relate to instant messaging communications over wireless networks.

2. Description of Related Art

Typical computer systems, especially computer systems using graphical user interface (GUI) systems, such as Microsoft WINDOWS, are optimized for accepting user input from one or more discrete input devices such as a keyboard for entering text, and a pointing device such-as a mouse with one or more buttons for driving the user interface.

Some computing systems have expanded the input and interaction systems available to a user by allowing the use of a stylus to input information into the systems. The stylus may take the place of both the keyboard (for data entry) as well as the mouse (for control). Some computing systems receive handwritten electronic information or electronic ink and immediately attempt to convert the electronic ink into text. Other systems permit the electronic ink to remain in the handwritten form.

Instant messaging applications currently exist. AOL® Instant Messenger™ 5.1 and MSN® Instant Messenger 5.0 are messaging applications that permit to one to transmit text, images, and other files to people on one's contact list. Other instant messaging applications are available. One common aspect of these instant messaging applications is that they all are limited to text as the primary information to be exchanged. If one wants to transfer an image or a file, one needs to request the recipient to accept the file. Stylus-based computing is not always predicated on the ability to input text. Accordingly, instant messaging applications need to be able to handle electronic ink from stylus-based computing applications as easily as they handle text.

Also, wireless computing is becoming popular. Because of the freedom provided by a wireless connection, one is not always confined to a specific location. The current model of having one connect to a predefined server (for example, at one's home or office) is being replaced by the ability to connect to various servers or peers passing messages for other peers as one changes location. Instant messaging applications will need to evolve to take advantage of the new ability to interconnect users.

### BRIEF SUMMARY

Aspects of the present invention address one or more of the issues mentioned above, thereby providing a better instant messaging environment. Aspects of the present invention included enhanced connectivity approaches so as to provide a robust network for users. Other aspects of the present invention included alternative messaging pathways including peer-to-peer messaging. Further, yet other aspects of the present invention include enhanced server routing techniques.

These and other aspects are addressed in relation to the Figures and related description.

### BRIEF DESCRIPTION OF THE DRAWINGS

The present invention is illustrated by way of example and not limited in the accompanying figures in which like reference numerals indicate similar elements and in which:

FIG. 1 shows a general-purpose computer supporting one or more aspects of the present invention.

FIG. 2 shows a display for a stylus-based input system according to aspects of the present invention.

FIG. 3 shows an instant messaging window in accordance with aspects of the present invention.

FIG. 4 shows a network topology in accordance with aspects of the present invention.

FIGS. 5A and 5B show various communication signals in networks in accordance with aspects of the present invention.

FIG. 6 shows a network including servers and separate authentication servers in accordance with aspects of the present invention.

FIG. 7 shows a network including clients having peer-to-peer messaging capabilities in accordance with aspects of the present invention.

FIG. 8 shows a network with alternative communication pathways in accordance with aspects of the present invention.

FIG. 9 shows various communication relationships between instant messaging users in accordance with embodiments of the present invention.

FIG. 10 shows an event-driven model for connecting users in a peer-to-peer instant messaging system.

### DETAILED DESCRIPTION OF THE DRAWINGS

Aspects of the present invention relate to providing a robust instant messaging application environment where users may connect in a variety of ways to different users. To assist the reader, the following description is subdivided into headings including the following: characteristics of ink; terms; general-purpose computing environment; ink-based instant messaging; peer-to-peer instant messaging; authentication servers and instant messaging; communication pathways; and instant messaging connections.

Characteristics of Ink

As known to users who use ink pens, physical ink (the kind laid down on paper using a pen with an ink reservoir) may convey more information than a series of coordinates connected by line segments. For example, physical ink can reflect pen pressure (by the thickness of the ink), pen angle (by the shape of the line or curve segments and the behavior of the ink around discreet points), and the speed of the nib of the pen (by the straightness, line width, and line width changes over the course of a line or curve). Because of these additional properties, emotion, personality, emphasis and so forth can be more instantaneously conveyed than with uniform line width between points.

Electronic ink (or ink) relates to the capture and display of electronic information captured when a user uses a stylus-based input device. Electronic ink refers to a sequence of strokes, where each stroke is comprised of a sequence of points. The points may be represented using a variety of known techniques including Cartesian coordinates (X, Y), polar coordinates (r, T), and other techniques as known in the art. Electronic ink may include representations of properties of real ink including pressure, angle, speed, color, stylus size, and ink opacity. Electronic ink may further include other properties including the order of how ink was deposited on a page (a raster pattern of left to right then down for most western languages), a timestamp (indicating when the ink was deposited), indication of the author of the ink, and the originating device (at least one of an identification of a machine upon which the ink was drawn or an identification of the pen used to deposit the ink) among other information.

Ink—A sequence or set of strokes with properties. A sequence of strokes may include strokes in an ordered form. The sequence may be ordered by the time captured or by where the strokes appear on a page or in collaborative situations by the author of the ink. Other orders are possible. A set of strokes may include sequences of strokes or unordered strokes or any combination thereof. Further, some properties may be unique to each stroke or point in the stroke (for example, pressure, speed, angle, and the like). These properties may be stored at the stroke or point level, and not at the ink level

Ink object—A data structure storing ink with or without properties.

Stroke—A sequence or set of captured points. For example, when rendered, the sequence of points may be connected with lines. Alternatively, the stroke may be represented as a point and a vector in the direction of the next point. In short, a stroke is intended to encompass any representation of points or segments relating to ink, irrespective of the underlying representation of points and/or what connects the points.

Point—Information defining a location in space. For example, the points may be defined relative to a capturing space (for example, points on a digitizer), a virtual ink space (the, coordinates in a space into which captured ink is placed), and/or display space (the points or pixels of a display device).

General-Purpose Computer

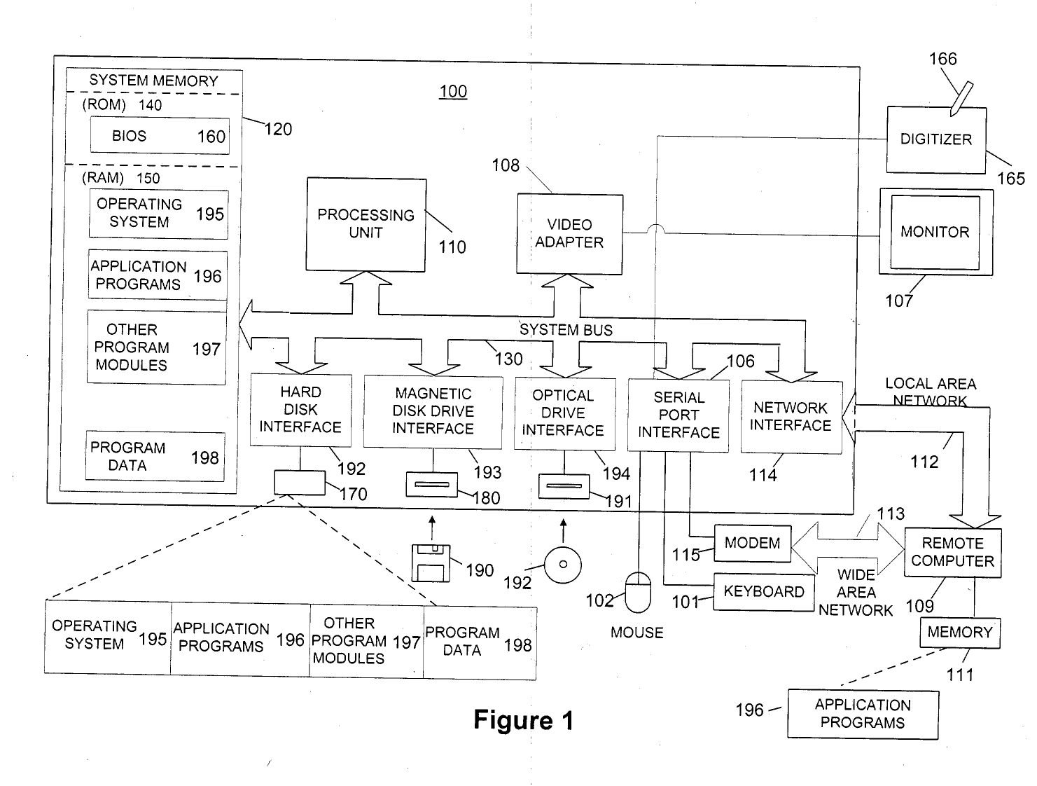

FIG. 1 illustrates a schematic diagram of an illustrative conventional general-purpose digital computing environment that can be used to implement various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 1-90, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). [at this point in time, since USB is so popular, you might want to feature USB in FIG. 1] Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as-speakers and printers. In one embodiment, a pen digitizer 165 and accompanying pen or stylus 166 are provided in order to digitally capture freehand input. Although a direct connection between the pen digitizer 165 and the serial port interface 106 is shown, in practice, the pen digitizer 165 may be coupled to the processing unit 110 directly, parallel port or other interface and the system bus 130 by any technique including wirelessly. Also, the pen 166 may have a camera associated with it and a transceiver for wirelessly transmitting image information captured by the camera to an interface interacting with bus 130. Further, the pen may have other sensing systems in addition to or in place of the camera for determining strokes of electronic ink including accelerometers, magnetometers, and gyroscopes.

Furthermore, although the digitizer 165 is shown apart from the monitor 107, the usable input area of the digitizer 165 may be co-extensive with the display area of the monitor 107. Further still, the digitizer 165 may be integrated in the monitor 107, or may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device. Further, the system may include wired and/or wireless capabilities. For example, network interface 114 may include Bluetooth, SWLan, and/or IEEE 802.11 class of combination abilities. It is appreciated that other wireless communication protocols may be used in conjunction with these protocols or in place of these protocols.

It will be appreciated that the network connections shown are illustrative and other techniques for establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

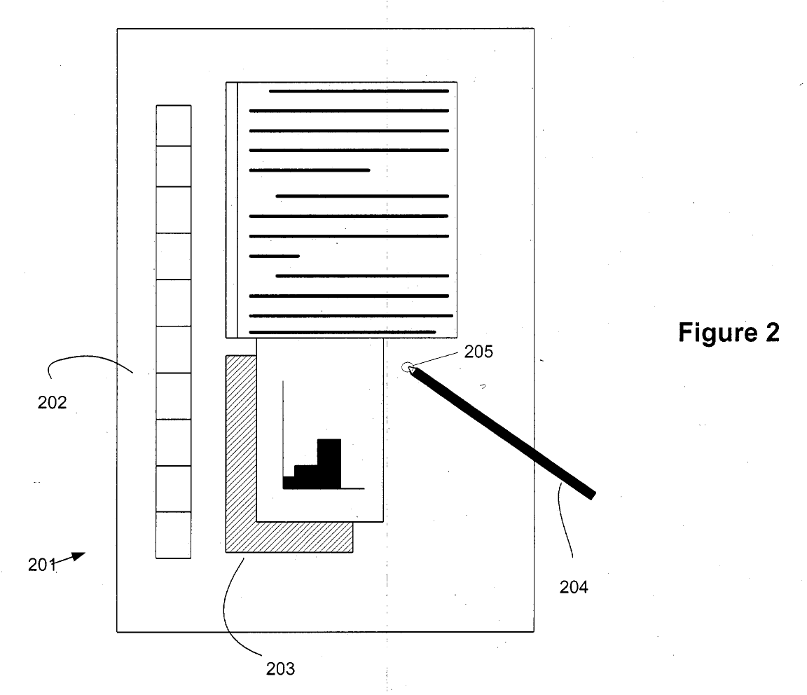

FIG. 2 illustrates an illustrative tablet PC 201 that can be used in accordance with various aspects of the present invention. Any or all of the features, subsystems, and functions in the system of FIG. 1 can be included in the computer of FIG. 2. Tablet PC 201 includes a large display surface 202, e.g., a digitizing flat panel display, preferably, a liquid crystal display (LCD) screen, on which a plurality of windows 203 is displayed. Using stylus 204, a user can select, highlight, and/or write on the digitizing display surface 202. Examples of suitable digitizing display surfaces 202 include electromagnetic pen digitizers, such as Mutoh or Wacom pen digitizers. Other types of pen digitizers, e.g., optical digitizers, may also be used. Tablet PC 201 interprets gestures made using stylus 204 in order to manipulate data, enter text, create drawings, and/or execute conventional computer application tasks such as spreadsheets, word processing programs, and the like.

The stylus 204 may be equipped with one or more buttons or other features to augment its selection capabilities. In one embodiment, the stylus 204 could be implemented as a “pencil” or “pen”, in which one end constitutes a writing portion and the other end constitutes an “eraser” end, and which, when moved across the display, indicates portions of the display are to be erased. Other types of input devices, such as a mouse, trackball, or the like could be used. Additionally, a user's own finger could be the stylus 204 and used for selecting or indicating portions of the displayed image on a touch-sensitive or proximity-sensitive display. Consequently, the term “user input device”, as used herein, is intended to have a broad definition and encompasses many variations on well-known input devices such as stylus 204. Region 205 shows a feedback region or contact region permitting the user to determine where the stylus 204 as contacted the display surface 202.

In various embodiments, the system provides an ink platform as a set of COM (component object model) services that an application can use to capture, manipulate, and store ink. One service enables an application to read and write ink using the disclosed representations of ink. The ink platform may also include a mark-up language including a language like the extensible markup language (XML). Further, the system may use DCOM as another implementation. Yet further implementations may be used including the Win32 programming model and the .Net programming model from Microsoft Corporation.

Ink-Based Instant Messaging

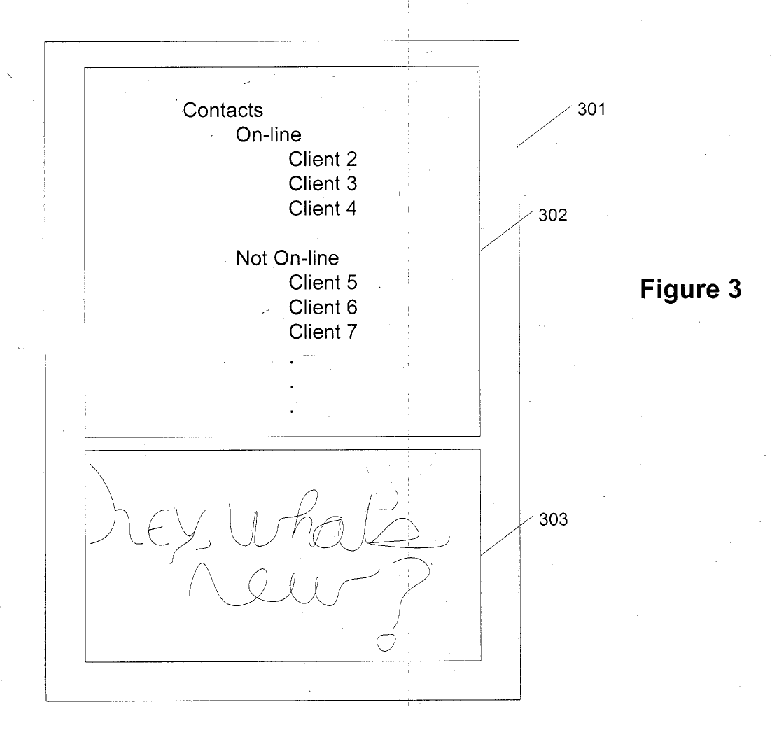

FIG. 3 shows an instant messaging region in accordance with aspects of the present invention. Region 301 is shown as having to sub-regions 302 and 303. A sub-region 302 includes two groups of contacts. For purposes of simplicity and explanation, the contacts of sub-region 302 are taken from the contacts of a user whose name is “client 1.” The first group of contacts includes clients 2, 3, and 4, who are currently online. The second group of contacts includes clients 5, 6, and 7, who are currently off line. Sub-region 303 shows an area for receiving an input message. Here, input message includes handwritten ink that may be relayed to a selected contact or contacts. It is appreciated that one may transmit and text, files, images, and other conventional datasets in place of handwritten ink as shown in sub-region 303.

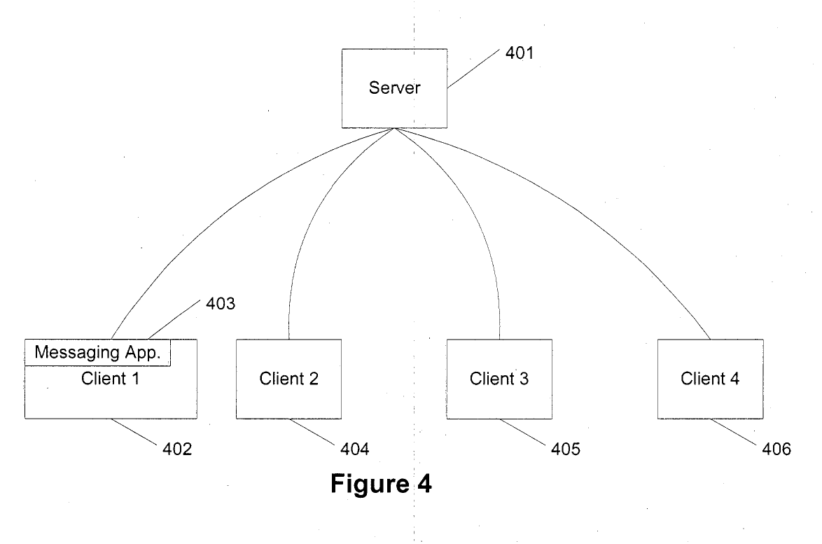

FIG. 4 shows a network for transmitting instant message information in accordance with aspects of the present invention. FIG. 4 includes a server 401 and a number of clients all interconnected through a wired and/or wireless network. The wireless network may include IEEE 802.11* (any of the IEEE 802.11 family of wireless protocols), Bluetooth, and any other wireless protocol. Client 1 402 includes a messaging application 403. The messaging application 403 is responsible for listening for instant messages from other clients or servers and coordinating appropriate application openings and closings.

FIG. 4 shows clients 2 404, 3 405, and 4 406. These clients may also have messaging application 403 running as well. Alternatively, they may have other messaging applications running. For example, one may have a messaging application 403 from a first company and another client may have messaging application from a second company.

Peer-To-Peer Instant Messaging

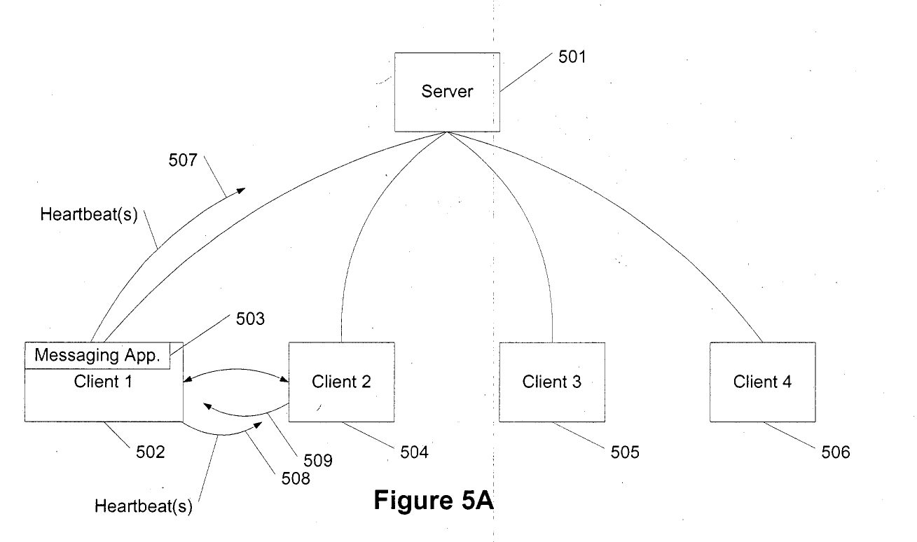

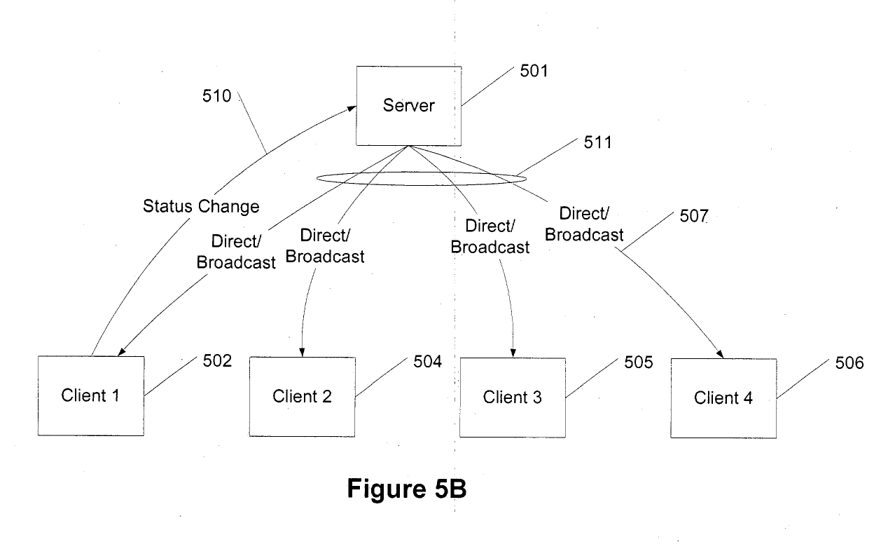

FIG. 5A shows a network with additional communication features. Server 501 is able to send and receive messages to each of client 1 502, client 2 504, client 3 505, and client 4 506. Additionally, client 1 502 and client 2 504 are able to transmit instant messages to each other directly, without transmitting the instant messages through server 501. This provides the benefit of being able to have a very secure conversation with another party (assuming the transmissions have been properly encrypted), since no record of the session exists on a server. This peer-to-peer messaging also provides the benefit of maximum bandwidth without artificial bandwidth constraints since message traffic is not limited by the capacity of the server. To establish a peer-to-peer messaging session, one may select one of the contacts from sub-region 302 and indicate (via drop-down menu, menu option, dialog box, radio button, predefined preferences and/or the like) that the user wants to establish a peer-to-peer messaging session with the recipient. The user may send an invitation to the IP address associated with the recipient, without any further use of the server. Once the invitation has been directly accepted by the recipient, both clients may now directly exchange instant messaging information as part of their conversation. The content they may exchange may include text, electronic ink, images, data files and the like.

The network of FIG. 5A may be wired or wireless. FIG. 5A also shows heartbeat signal 507 being transmitted from client 1 503 to server 501. A variety of different heartbeat signaling procedures are possible. For example, client 1 may transmit a heartbeat signal 507 to server 501 every 45 seconds. If the server 501 does not receive a heartbeat from client 1 502 for two intervals (for instance, of course other intervals are possible), server 501 would then indicate that client 1 502 is offline. An alternative approach includes using a delayed heartbeat signal that senses user interaction with client 1 502. If a user does not interact with client 1 502 for a given period of time (for example, five minutes), then the rate of heartbeat signals 507 may be decreased. Decreasing the rate of heartbeat signals lessens the processing load on server 501 for users who are away from a client. In yet a further aspect of the invention, heartbeat signals 508 may be received by other clients. These clients may individually update their contact list based on the reception of heartbeat signals from other clients. For example, if client 1 502 was on client 2 504's contact list and both client 1 and client 2 could receive each other's heartbeat signals 508 and 509, then each could update their own contact list with status information for the other client. If however, clients 1 and 2 move out of each other's range or connection between them is lost, then they would list each other respectively as being offline for peer-to-peer messaging. It is appreciated that a number of different heartbeat transmission systems may be used in accordance with aspects of the present invention.

FIG. 5B shows another aspect of the present invention. FIG. 5B includes server 501 and clients 1-4 502 and 504-506, respectively. Here, client 1 502 is changing its status. The change of status information is transmitted to server 501 as status change message 510. In order to update each of the remaining clients as to the status of client 1 502, server 501 transmits an update message 511 to all clients. In one aspect, the message 511 may be directed to each client currently within wireless radio contact of server 501. Also, the message 507 may be individually targeted to each client. Alternatively, the message 507 may be broadcast message which is sent to all clients within reception range. The broadcast message may take the form of a UDP message to all clients. The benefit of a broadcast message is that it permits the remaining clients to immediately reflect an updated status information for client 1 502 in their contact list. Another benefit of a broadcast message is that it minimizes the likelihood of return messages being generated by receiving clients as compared to a standard direct communication.

Authentication Servers And Instant Messaging

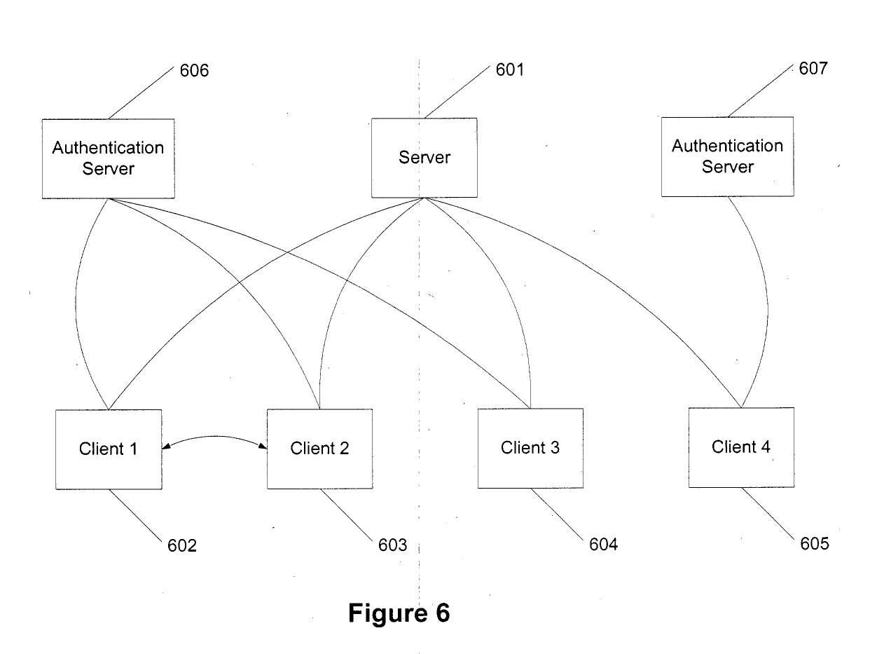

FIG. 6 shows an aspect of the present invention in which authentication servers may be separated from servers handling traffic in support of instant messaging. Server 601 handles presence information traffic between client 1 602, client 2 603, client 3 604, and client 4 605. Presence information includes the ability to contact a client based on the client's physical location. Client 1 602, client 2 603, and client 3 604 are supported by authentication server 606. So, when any of clients 1-3 need to be authenticated to an instant messaging system, they communicate with authentication server 606. Client 4 605-communicates with authentication server 607 for its instant messaging communication authentication. Peer-to-peer messaging is included in FIG. 6 at least by the showing of the peer to peer messaging between client 1 602 and client 2 603.

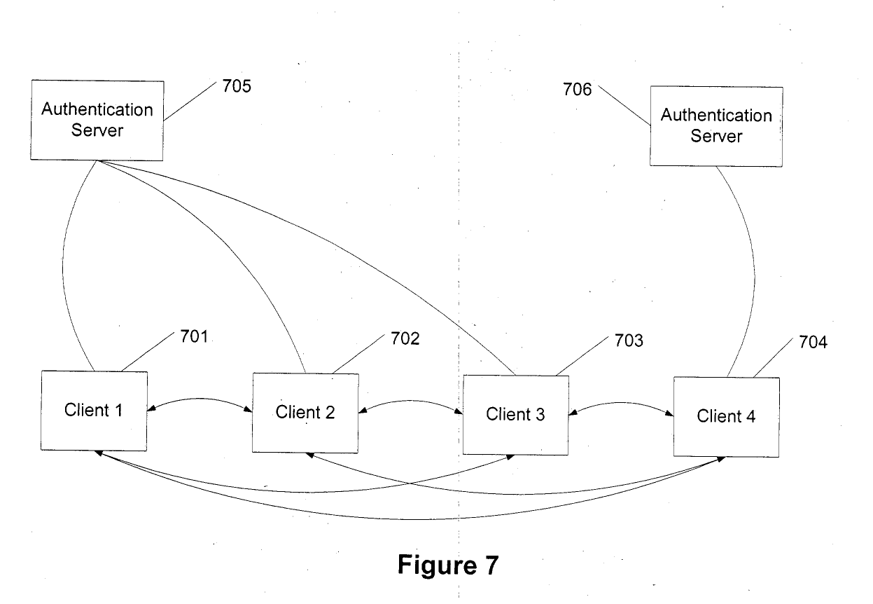

FIG. 7 shows another aspect of the present invention in which no centralized server is used to transfer instant messaging traffic between clients. Rather, instant messaging traffic is transferred on a peer-to-peer basis. Client 1 701, client 2 702, client 3 703, and client 4 704 all communicate with each other using peer-to-peer messaging. Authentication servers 705 and 706 handle the authentication for the various clients (here, authentication server 705 handling the authentication for clients 1-3 and authentication server 706 handling the authentication for client 4). The presence information may be handled on a peer-to-peer basis. For instance, client 1 701 may regularly transmit heartbeat signals to other clients with whom client 1 701 has established a peer-to-peer network. This transmission of heartbeat signals may occur as direct transmissions to each client or may occur as a broadcast message to all surrounding clients. The broadcast message may take the form of a UDP broadcast message.

Communication Pathways

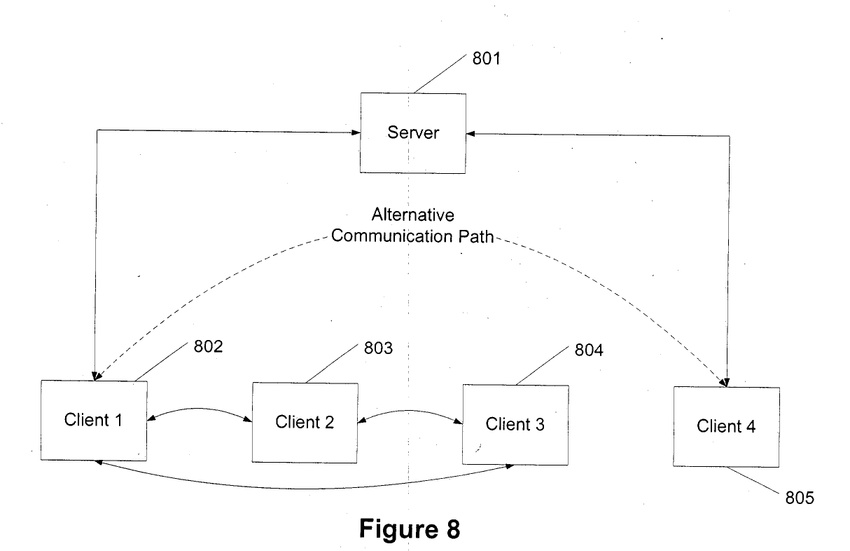

FIG. 8 shows various applications pathways between clients. Server 801 is shown to as well as clients 1-4 802-805, respectively. Client 1-3 802-804 respectively are shown as communicating directly using wireless peer-to-peer communication pathways. Client 4 805 is out of range or is obstructed from communicating with the remaining three clients 802-804. So to communicate with client 1 802, client 4 805 sends its instant messaging traffic through server 801, who then routes the appropriate traffic to client 1 802. Further, in yet another aspect of the present invention, client 4 805 may be able to see and communicate with clients 2 803 and 3 804 by using the connection through client 1 802. This ability to instant message using an intermediate client is related to mesh network technologies and provides the benefit of being able to connect where one would not normally be able to connect. It is appreciated that the ability to communicate with one client through an intermediate client is optional and is not required to practice every aspect of the present invention.

Instant Messaging Connections

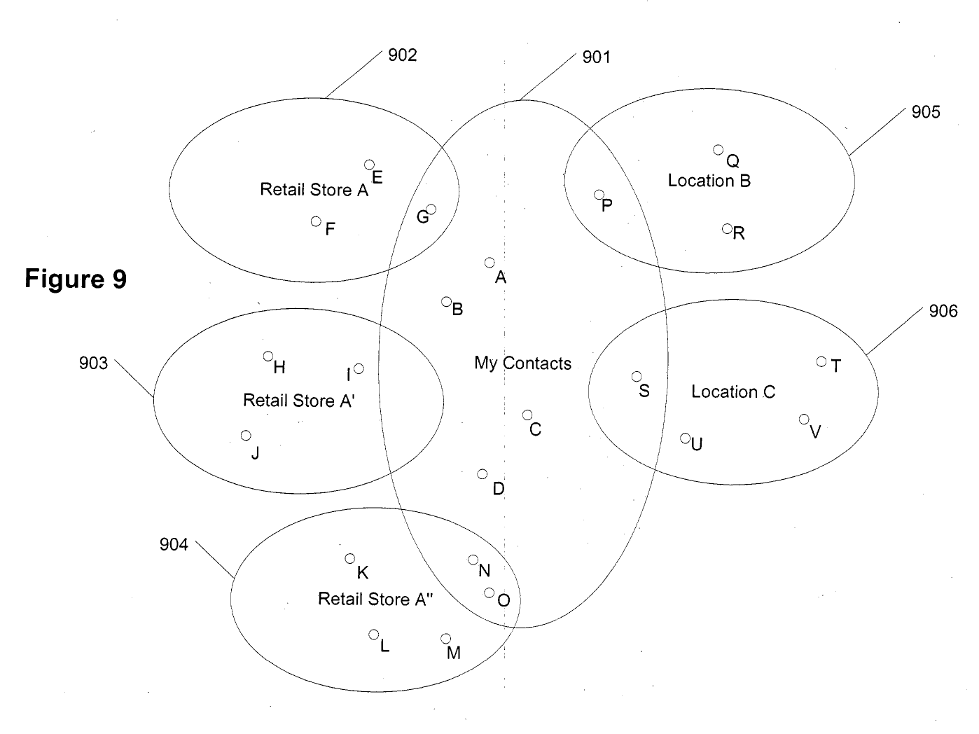

FIG. 9 shows various connections available to a user. The connections described below relate to the following: membership lists; contact lists; and presence. A membership list relates to all members that a user may communicate with, a contact list is the user's personal contact list including his subset of contacts with whom he would like to exchange instant messages and their state of whether they are online or offline, and presence where a user may interact with another based on the other's physical location. FIG. 9 shows three retail stores (retail store A 902, retail store A′ 903 and retail store 904 A″). Retail stores 902-904 are all connected together (for example, via the internet), thereby permitting users at one store to communicate with users at other stores.

FIG. 9 shows the My Contacts list (901) for user “G.” The members of G's contact list are at various locations. For example, member P is at location B 905, member S is at location C 906, and members N and 0 are at retail store A″ 904. User “G” is currently in retail store A 902. Online users (whether they are on a user's contact list or not) are provided with the designator A-V, respectively. When in retail store A 902, user G's wireless connection permits him to connect to a wireless access point in retail store A and communicate with his contacts A, B, C, D, N, 0, P, and S (over the internet, for instance). Also, user G may be permitted to establish a peer-to-peer connection with other users who are in retail store A 902 including E and F. Further, the retail store A 902 may permit user G to determine and instant message other users who are at other locations of retail store A 902 including A′ 903 and A″ 904, thereby including users H, I, and J from retail store A′ 903 and users K, L, M, N, and O from retail store A″ 904. Beyond the normal use of wireless to obtain an internet connection, this example shows how local access points can form a community (or set of communities) that can be used as an extension to a user's contact list.

Further, in yet another aspect of the present invention, if mesh networks are implemented, user G may be able to interact with other users based on presence provided by users on user G's contact list 901. For example, user G may be able to communicate with the other users in retail store A″ 904 K, L and M by the presence of at least one of N and 0 from user G's contact list 901. Likewise, user G may communicate with users Q and R at location B 905 through user P and users T, V and U at location C 906 through user S. It is noted that in this mesh network example, user G is prevented from establishing an instant messaging communication pathway width of the users in retail store A′ 903 as none of G's contacts are in retail store A′ 903. It is appreciated that other examples and pathways may be used to establish its messaging communications between various users.

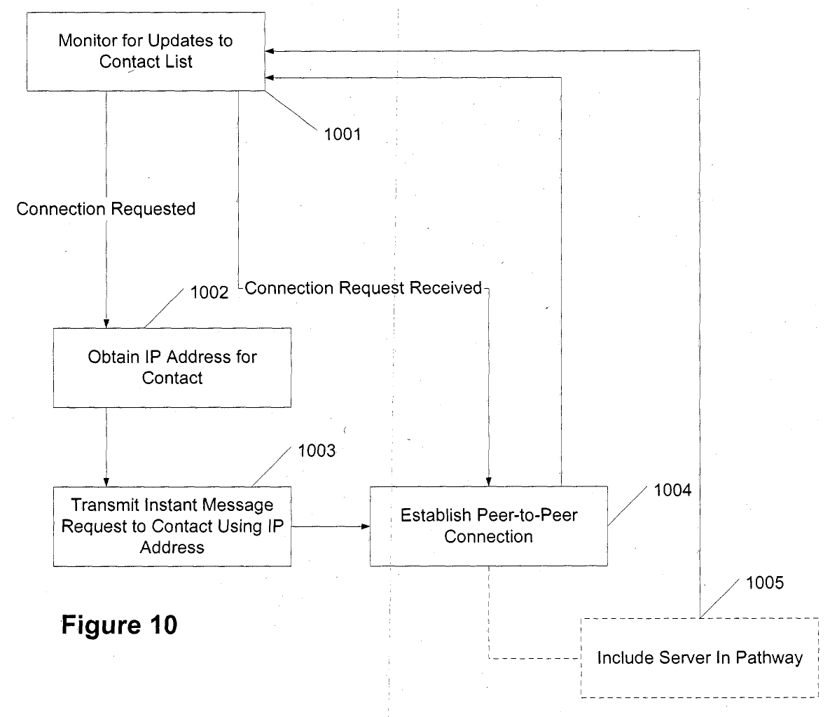

FIG. 10 shows an event driven model for establishing a peer-to-peer instant message communication. At point 1001, the system monitors for updates to a user's contact list, accumulating the current online status and IP address of the contact list members in the process. If a connection request event is received, the system uses the accumulated IP address of the target contact at point 1002 and transmits an instant message request or other appropriate signaling to the contact at point 1003. Next, at 1005, the system establishes the peer-to-peer connection. If a connection request was received, the system then attempts to establish the connection with the user at 1004. The system then returns to point 1001 and continues to monitor for updates to a contact list. FIG. 10 shows optional event handling shown in broken lines 1005 that may be used if a connection is not possible between a first and second user. Similar to the example shown in FIG. 8, a user may attempt to establish a connection with a user through a server that has connectivity with the remote user.

Aspects of the present invention have been described in terms of illustrative embodiments thereof. Numerous other embodiments, modifications and variations within the scope and spirit of the appended claims will occur to persons of ordinary skill in the art from a review of this disclosure.

We claim:

1. An instant messaging system comprising:
a server;
at least two clients, who communicate wirelessly with said server;
wherein said server receives heartbeat notification signals from said clients

2. The instant messaging system according to claim 1, wherein said server transmits signals to said clients regarding the status of said clients.

3. The instant messaging system according to claim 2, wherein said status signals transmitted by said server includes UDP broadcast messages.

4. The instant messaging system according to claim 2, wherein said status signals transmitted by said server includes direct messages to each client.

5. The instant messaging system according to claim 1, wherein said clients are able to transmit electronic ink to each other.

6. A wireless instant messaging system comprising.
a first client having an instant messaging application and a wireless connection;
a second client having an instant messaging application and a wireless connection,
wherein said first client and said second client establish a wireless peer-to-peer connection and transmit instant messages over the connection.

7. The wireless instant messaging system according to claim 6, further comprising:
a third client having an instant messaging application; and
a server, said server forwarding instant message requests for sessions and ink information between said third client and one of said first and second clients.

8. A process for establishing a peer-to-peer instant messaging pathway between a first and second users comprising the steps of:
obtaining at a first user the IP address of a contact relating to said second user;
transmitting a request to the IP address of the contact of said second user;
establishing said peer-to-peer instant messaging pathway between said first user and said second user.

9. The process according to claim 8, further comprising the steps of:
determining that a peer-to-peer connection cannot be established directly between said first and second users; and
using a server that has connection to both users to help establish a connection between said users.

10. A computer-readable medium having a program stored thereon, said program including steps for establishing a peer-to-peer instant messaging pathway between a first and second users, said program comprising the steps of:
obtaining at a first user the IP address of a contact relating to said second user;
transmitting a request to the IP address of the contact of said second user;
establishing said peer-to-peer instant messaging pathway between said first user and said second user.

11. The computer-readable medium according to claim 10, further comprising the steps of:
determining that a peer-to-peer connection cannot be established directly between said first and second users; and
using a server that has connection to user to help establish a connection between said users.

12. An instant messaging network comprising:
a first user with a contact list relating to at least a second user;
a third user not on the contact list of said first user but within a peer-to-peer networking range of said second user;
wherein said first user is able to exchange instant messages with said third user by said second user relaying said instant messages.
